(19) United States
(12) Patent Application Publication
(10) Pub. No.: US 2006/0037446 A1
(43) Pub. Date: Feb. 23, 2006

(54) Angled crosscut knife

(75) Inventors: John J. Seyna, Williamson, NY (US); Robert G. Spencer, Rochester, NY (US); Genival D. Barros, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/920,624

(22) Filed: Aug. 18, 2004

(51) Int. Cl. B26D 1/00

(52) U.S. Cl. 83/13; 83/581

(57) ABSTRACT

An apparatus (10) and method for crosscutting a web (12) of material has employs a knife (24) that is angled relative to the surface of the web. Orienting the knife so that an upper portion of the cutting edge engages the web after a lower portion of the cutting edge engages the web facilitates cutting the web at a transverse cut angle (β) of about 20 degrees. Simultaneously orienting the knife so that the upper portion of the cutting edge engages the web at a different position along the side edge than the lower portion of the cutting edge facilitates cutting the web at a horizontal cant angle (α) in the range of about 10 degrees to about 50 degrees.

### FIELD OF THE INVENTION

The invention relates generally to the field of cutting technology, and in particular to photographic paper cutting. More specifically, the invention relates to razor crosscutting of photographic paper.

### BACKGROUND OF THE INVENTION

All paper slitters use some kind of cutting mechanism, usually a razor blade, to cut across the web when the correct length has been spooled on the core. After this crosscutting operation, the end of the spooled web is taped down and the finished roll is then bagged for the eventual customer. A web of photographic paper may consist of several layers of material. The current method of crosscutting photographic product webs is to use a razor blade angled perpendicular (90 degrees) to the web, and urge the blade through the web. This often results in a rough cut, with the cut edges upset due to the product being displaced by the trailing heel of the razor blade. This upset results in core impressions on the first few wraps of product around the core. Core impressions are a problem that may render the first few wraps of product adjacent the core unusable.

Additionally the rough cut results in more dirt and debris being produced. Dirt and debris are problematic because they must be removed or else they will contaminate the photographic paper web reducing its quality or making it unusable. Dirt and debris may also cause more rapid wear of the razor knife. The forces required to urge the blade through the web also results in reduced knife life.

Accordingly, it will be appreciated that it would be highly desirable to crosscut a photographic paper web in a smooth cut without upsetting the edges of the web and without producing wasteful core impressions. It is also desirable to produce a clean, effortless cut that minimizes the production of dirt and debris. At the same time, maximum razor knife life is desired to increase intervals between razor knife replacement thereby increasing efficiency.

### SUMMARY OF THE INVENTION

The present invention is directed to overcoming one or more of the problems set forth above. Briefly summarized, according to one aspect of the present invention, an apparatus for crosscutting a web of material wherein the web has front and rear side edges and lies in a plane having horizontal and transverse boundaries comprises a mounting block, a support member and a knife. The support member has an inclined surface and is attached to the support member. The knife is disposed on the inclined surface of the support member. The knife has a razor edge angled from vertical, both horizontally and transversely, so that the razor edge engages the web at a horizontal cant angle and a transverse cut angle of about 20 degrees. The inclined surface of the support member is inclined at the horizontal cant angle which is in the range of about 10 degrees to about 50 degrees.

According to another aspect of the invention, a method for crosscutting a web using a reduced cutting force comprises mounting a knife having a cutting edge for movement into contact with the web to cut the web from one side edge of the web to the opposite side edge of the web, orienting the knife so that an upper portion of the cutting edge engages the web after a lower portion of the cutting edge engages the web thereby cutting the web at a transverse cut angle, and orienting the knife so that the upper portion of the cutting edge engages the web at a different position along the side edge than the lower portion of the cutting edge thereby cutting the web at a horizontal cant angle. The horizontal cant angle is in the range of about 10 degrees to about 50 degrees, and the transverse cut angle is about 20 degrees.

Angling the knife allows the knife to easily and neatly cut through the web instead of merely ploughing through the web. Angling the knife to crosscut a photographic paper web produces a smooth cut without upsetting the edges of the web and while minimizing wasteful core impressions. The force required to cut the web is reduced by angling the knife producing a clean, effortless cut that minimizes the production of dirt and debris. Maximum razor knife life is obtained when the knife is angled which increases intervals between razor knife replacement thereby increasing productivity. A crosscut knife that is angled to the paper surface will use less force, produce a better quality cut and extend knife life while producing an angled cut edge to eliminate core impressions.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a perspective view of a crosscut knife assembly according to the present invention;

FIG. 2 is a diagrammatic end view of a knife angled at 90 degrees (zero cant) cutting a paper web;

FIG. 3 is a diagrammatic end view of a canted knife cutting a paper web;

FIG. 4 is a diagrammatic end view of an angled knife cutting a paper web according to the present invention;

FIG. 5 is a diagrammatic front view of an angled knife cutting a paper web according to the present invention;

FIG. 6 is a graph showing force vs. angle data for hook style knives;

FIG. 7 is a graph showing force vs. angle data for WC2 style knives; and

FIG. 8 is a graph showing force vs. angle data for single edge knives.

### DETAILED DESCRIPTION OF THE INVENTION

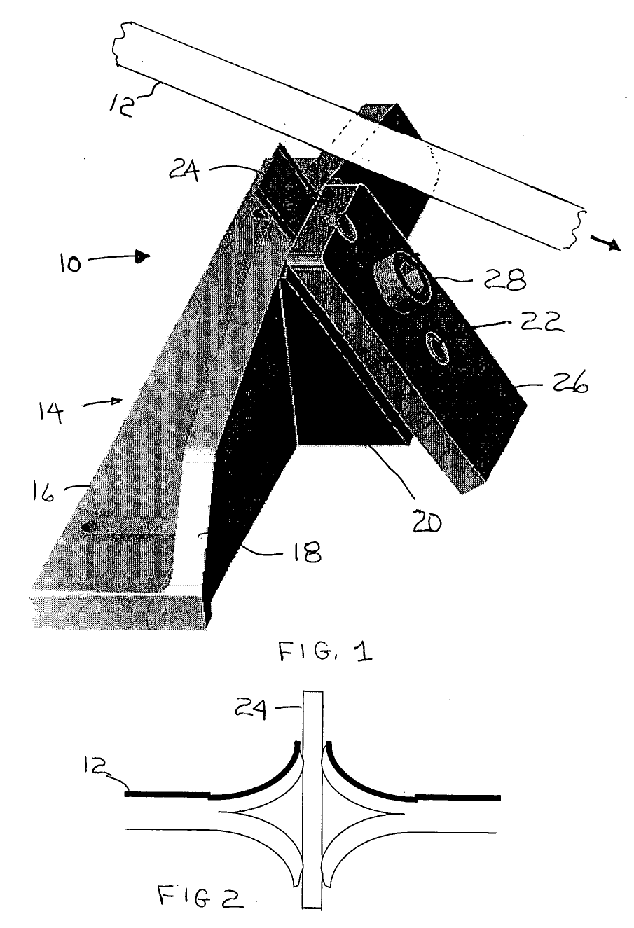

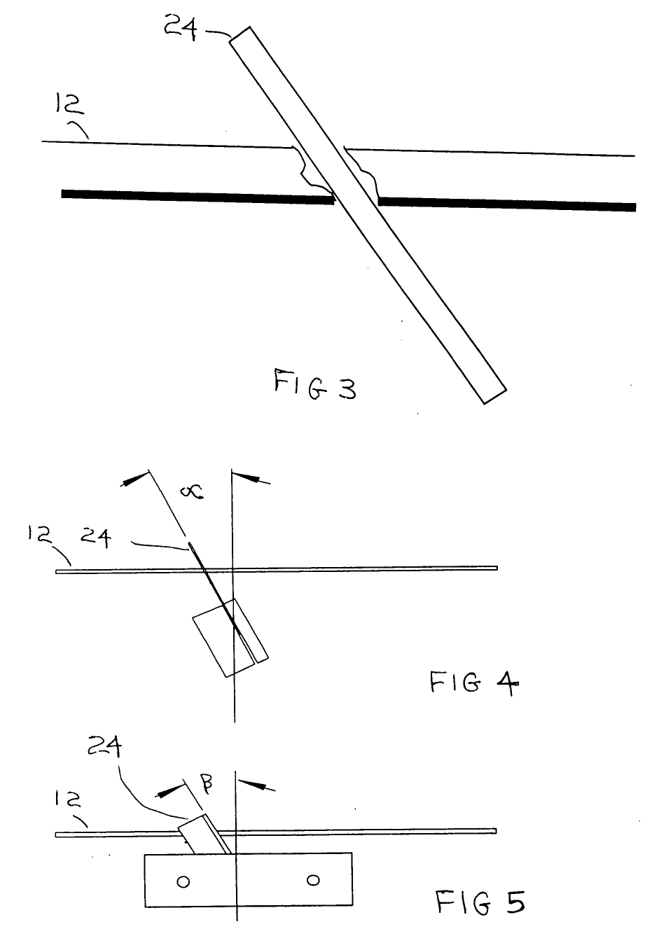

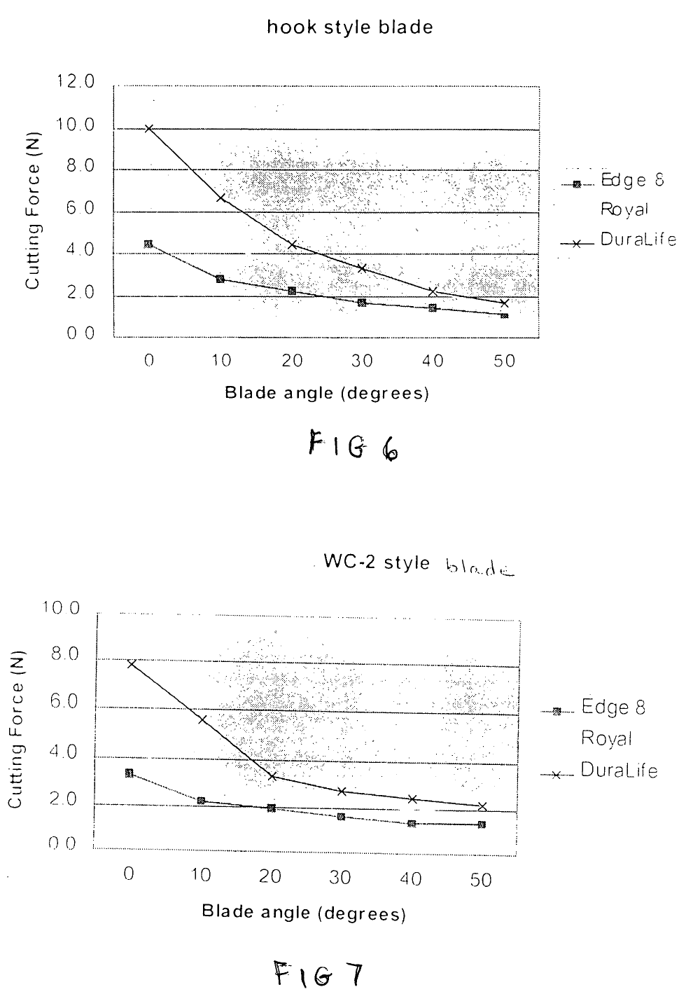

Referring to FIGS. 1-5, an apparatus 10 is configured for crosscutting a web 12 of material wherein the web 12 has front and rear opposed side edges and lies in an xy plane having horizontal and transverse boundaries. Such a plane would have x and y Cartesian coordinates with the web traveling in the x direction. The apparatus includes a mounting block 14 that is preferably movable in the y direction to intersect and cut the web. Mounting block 14 preferably has a base 16 and an upstanding flange 18. Base 16 lies parallel to the xy plane and flange 18 extends in the z direction.

A support member 20 has an inclined surface and is attached to flange 18 with the inclined surface facing outward away from flange 18. The inclined surface is tilted relative to the xy plane and thus to the web at a cant angle, α. It is preferred that support member 20 be removably mounted on flange 18 to facilitate tilting the inclined surface by removing one support member and replacing it with a different one with the desired degree of incline. When removably mounted, support member 20 may rest on support pins 22 that extend from flange 18 through openings in support member 20 or may be attached to flange 18 with screws or the like. Where there is no desire to change support member 20, it may be fastened to flange 18 by welding or the like.

A knife 24 is disposed on the inclined surface of support member 20 and is thus disposed at cant angle α relative to the web. The knife has a razor cutting edge that is angled from vertical (z axis) both horizontally and transversely so that the razor edge engages the web at a horizontal cant angle, α, and a transverse cut angle, β.

A retaining plate 26 is disposed atop the knife 24 and is fixed in position by a locking screw 28. Locking screw 28 engages flange 18 or support member 20 where support member 20 is fixed to flange 18. Retaining plate 26 preferably has openings for receiving support pins 22. Locking screw 28 and support pins 22 form a means for detachably attaching the retaining plate 26 to one of the support member 20 and the flange 18 of mounting block 14.

The knife 24 is fixed at the cut angle by retaining plate 26 and locking screw 28. Loosening retaining plate 26 allows the transverse cut angle to be changed as desired. Support pins 22 may extend through slots in knife 24 to facilitate changing the transverse cut angle.

Crosscut is defined as the process of cutting through a web of photographic product, perpendicular to it's direction of travel, so as to part the web from the master roll. Laboratory testing, as well as prototype use, has shown that by canting the blade angle from 0 degree cant (90 degree perpendicular to the web) to an angle between 20-50 degrees of cant, the cut edge upset is eliminated and cutting forces are greatly reduced, resulting in greatly extended knife life and less dirt and debris.

Regarding the elimination of cut edge upset; it has been found that rather than displace product with the blade heel as it cuts through the web (when at 0 degrees of cant), the angled blade tends to steer the product web over and under the blade. This virtually eliminates the cut edge upset and the subsequent core impressions (of the upset) on the first few wraps of product around the core resulting in more usable product per roll. Additionally, laboratory tests showed the cut quality to be at least 100% better, hence cleaner, than the 0 degree cant angle cut.

With regard to the reduction in the forces required to cut through the web, lab tests show that at 90 degree perpendicularity to the product (0 degree cant) the force required to cut through the web were 10 Newtons (2.24 lbs.), 6 Newtons (1.34 lbs), and 4 Newtons (0.89 lbs.), respectively for 3 different products tested. In each case the forces dropped when the blade angle was canted at 20 degrees from perpendicular to the product to 3.8 Newtons (0.85 lbs.), 2.4 Newtons (0.54 lbs.), and 2.2 Newtons (0.5 lbs). This represents a force drop of between 40% and 60% (depending on product) for a cant angle of 20 degrees. At a 50 degree cant angle, the forces required, dropped from between 70% to 80% of that required at a 90 degree perpendicularity (0 degree cant angle). This results in a blade life extension of 400%.

The blade cant angle is the angle of inclination with respect to the web surface, perpendicular to the cutting direction. The cut angle is the blade angle in the direction of blade travel, in this case angled back 20 degrees, for all tests.

We tested three blade styles, three paper types, and six cant angles, as listed in the table below:

| Blade style | Paper | Cant angle |
|---|---|---|
| carbide WC-2 | Edge 8 | 0 |
| Tekli hook | Royal | 10 |
| single edge | DuraLife | 20 |
| | | 30 |
| | | 40 |
| | | 50 |

Each blade was tested using all three papers at the various cant angles. The paper was pulled through the blade at a constant slow velocity and the pulling force recorded. The effect at 0 degrees (perpendicular to the paper surface) was quite different than at any of the angles. The paper was forced apart at the cut point, and split nearly in half, leaving a large raised edge top and bottom.

When a cant angle is used, the paper does not behave in the same manner. The blade cuts through the paper, one cut edge moves up, and the other down. The cutting force is much less because the paper is not being forced apart, it is neatly cut.

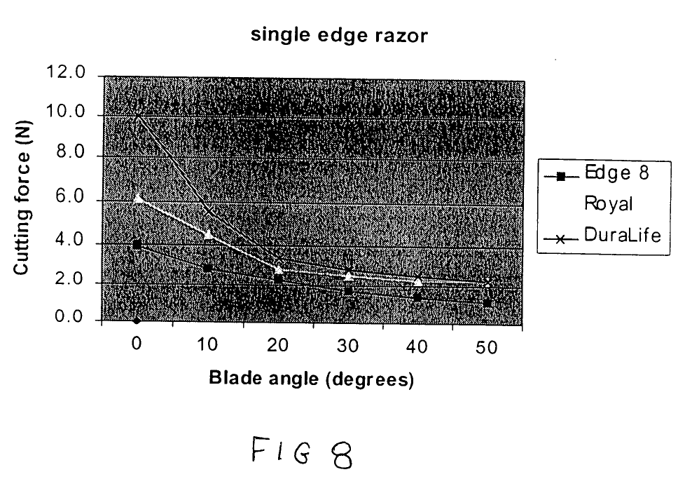

The higher cutting force at 0 degrees is caused by the plowing action of the blade. All three blades indicated high cutting force at 0 degrees. The paper is forced apart, the thicker and stronger the paper, the higher the forces, and this was seen with the Royal and DuraLife papers where the forces were indeed higher. Graphs of all combinations are shown in FIGS. 7-9.

As the blade is inclined, it causes an angled edge, which is advantageous for the core end, where it helps to minimize end cut impressions, but it will look visually different than a square cut. At some point, it is assumed that the cutting force will start to increase as the angle is increased, caused by the greater effective paper thickness, but even at 50 degrees the cutting force was still very low compared with 0 degrees. For DuraLife paper, the difference was remarkable: 10.0N at 0 degrees compared with less than 2.0N at 50 degrees, using hook style blades. Lower cutting forces translate to longer blade life, better cut quality, and fewer setup problems.

It can now be appreciated that an apparatus and method for crosscutting a web of material has been presented. The apparatus includes a knife that is angled relative to the surface of the web. The method for crosscutting a web using a reduced cutting force includes mounting the knife and orienting the knife. Mounting a knife having a cutting edge for movement into contact with the web to cut the web from one side edge of the web to the opposite side edge of the web cuts the web to the desired length. Orienting the knife so that an upper portion of the cutting edge engages the web after a lower portion of the cutting edge engages the web facilitates cutting the web at a transverse cut angle. Orienting the knife so that the upper portion of the cutting edge engages the web at a different position along the side edge than the lower portion of the cutting edge facilitates cutting the web at a horizontal cant angle. The horizontal cant angle is in the range of about 10 degrees to about 50 degrees, and the transverse cut angle is about 20 degrees.

The invention has been described with reference to a preferred embodiment; However, it will be appreciated that variations and modifications can be effected by a person of ordinary skill in the art without departing from the scope of the invention. For example, while it is contemplated that the knife will move to the web, it is possible for the web to move to the knife. Also, it is possible to move the knife relative to the mounting block instead of moving the knife with the mounting block. In addition, the angle of incline of the inclined surface of the support member may be changed by using wedges instead of replacing the support member.

### PARTS LIST

10 crosscutting apparatus
12 web of material
14 mounting block
16 base of mounting block
18 flange of mounting block
20 support member having an inclined surface
22 support pins
24 knife with razor edge
26 retaining plate
28 locking screw

1. An apparatus for crosscutting a web of material, said web having front and rear side edges and lying in a plane having horizontal and transverse boundaries, said apparatus comprising:
a mounting block;
a support member having an inclined surface and being attached to said support member; and
a knife disposed on said inclined surface of said support member, said knife having a razor edge angled from vertical both horizontally and transversely so that said razor edge engages the web at a horizontal cant angle and a transverse cut angle, said inclined surface of said support member being inclined at said horizontal cant angle.

2. Apparatus recited in claim 1 including:
a retaining plate disposed atop said knife; and
means for detachably attaching said retaining plate to one of said support member and said mounting block.

3. Apparatus recited in claim 2 wherein said means includes at least one retaining pin extending into said retaining plate and said support member, and a locking screw extending from said retaining plate into one of said support member and mounting block.

4. Apparatus recited in claim 3 wherein said knife is fixed at said cut angle by said retaining plate and locking screw.

5. Apparatus recited in claim 1 wherein said horizontal cant angle is in the range of about 10 degrees to about 50 degrees.

6. Apparatus recited in claim 1 wherein said transverse cut angle is about 20 degrees.

7. A method for crosscutting a web using a reduced cutting force, comprising the steps of:
mounting a knife having a cutting edge for movement into contact with the web to cut the web from one side edge of the web to the opposite side edge of the web;
orienting the knife so that an upper portion of said cutting edge engages the web after a lower portion of said cutting edge engages the web thereby cutting the web at a transverse cut angle; and
orienting the knife so that said upper portion of said cutting edge engages the web at a different position along the side edge than said lower portion of said cutting edge thereby cutting the web at a horizontal cant angle.

8. The method recited in claim 7 wherein said horizontal cant angle is in the range of about 10 degrees to about 50 degrees.

9. The method recited in claim 7 wherein said transverse cut angle is about 20 degrees.
